(19) United States
(12) Patent Application Publication
(10) Pub. No.: US 2014/0200971 A1
(43) Pub. Date: Jul. 17, 2014

(54) SYSTEM AND METHOD FOR MATCHING INFORMATIVE CONTENT TO A MULTIMEDIA CONTENT ELEMENT BASED ON CONCEPT RECOGNITION OF THE MULTIMEDIA CONTENT

(71) Applicant: CORTICA, LTD., Ramat Gan (IL)

(72) Inventors: Igal Raichelgauz, Ramat Gan (IL); Karina Odinaev, Ramat Gan (IL); Yehoshua Y. Zeevi, Haifa (IL)

(73) Assignee: CORTICA, LTD., Ramat Gan (IL)

(21) Appl. No.: 14/212,213

(22) Filed: Mar. 14, 2014

Related U.S. Application Data
(63) Continuation-in-part of application No. 13/856,201, filed on Apr. 3, 2013.
Application No. 13/856,201 is a continuation-in-part of application No. 13/624,397, filed on Sep. 21, 2012.
Application No. 13/624,397 is a continuation-in-part of application No. 13/344,400, filed on Jan. 5, 2012.
Application No. 13/344,400 is a continuation of application No. 12/434,221, filed on May 1, 2009, now Pat. No. 8,112,376.
Application No. 13/624,397 is a continuation-in-part of application No. 12/195,863, filed on Aug. 21, 2008, now Pat. No. 8,326,775.
Application No. 12/195,863 is a continuation-in-part of application No. 12/084,150, filed on Apr. 7, 2009, now Pat. No. 8,655,801.
Application No. 13/624,397 is a continuation-in-part of application No. 12/084,150, filed on Apr. 7, 2009, now Pat. No. 8,655,801.
(60) Provisional application No. 61/789,510, filed on Mar. 15, 2013.
(60) Provisional application No. 61/766,016, filed on Feb. 18, 2013.

(30) Foreign Application Priority Data
Oct. 26, 2005 (IL) 171577
Jan. 29, 2006 (IL) 173409
Aug. 21, 2007 (IL) 185414

(51) Int. Cl. G06Q 30/02

(52) U.S. Cl. CPC G06Q 30/0263
USPC 705/14.6

(57) ABSTRACT

A method and system for matching informative content to a multimedia content element are provided. The method comprises identifying the multimedia content element in a web-page displayed on a user node; generating at least one signature for the multimedia content element; determining a user impression respective of at least one multimedia content element; determining at least one matching concept based on the at least one generated signature and the determined impression; searching for matching informative content based on the matching concept; and determining a display area within the multimedia content element over which the matched informative content can be displayed.

### CROSS-REFERENCE TO RELATED APPLICATIONS

This application claims the benefit of U.S. Provisional Application No. 61/789,510 filed on Mar. 15, 2013, the contents of which are hereby incorporated by reference. This application is also a continuation-in-part (CIP) of U.S. patent application Ser. No. 13/856,201 filed on Apr. 3, 2013, now pending, which claims the benefit of U.S. Provisional Application No. 61/766,016 filed on Feb. 18, 2013. The Ser. No. 13/856,201 Application is a continuation-in-part (CIP) of U.S. patent application Ser. No. 13/624,397 filed on Sep. 21, 2012, now pending. The Ser. No. 13/624,397 Application is a continuation-in-part of:

(a) U.S. patent application Ser. No. 13/344,400 filed on Jan. 5, 2012, now pending, which is a continuation of U.S. patent application Ser. No. 12/434,221, filed May 1, 2009, now U.S. Pat. No. 8,112,376;

(b) U.S. patent application Ser. No. 12/195,863, filed Aug. 21, 2008, now U.S. Pat. No. 8,326,775, which claims priority under 35 USC 119 from Israeli Application No. 185414, filed on Aug. 21, 2007, and which is also a continuation-in-part of the below-referenced U.S. patent application Ser. No. 12/084,150; and,

(c) U.S. patent application Ser. No. 12/084,150 with a filing date of Apr. 7, 2009, now U.S. Pat. No. 8,655,801, which is the National Stage of International Application No. PCT/IL2006/001235, filed on Oct. 26, 2006, which claims foreign priority from Israeli Application No. 171577 filed on Oct. 26, 2005 and Israeli Application No. 173409 filed on 29 Jan. 2006.

All of the applications referenced above are herein incorporated by reference for all that they contain.

### TECHNICAL FIELD

The present invention relates generally to the analysis of multimedia content elements, and more specifically for matching advertised content to multimedia content elements based on such analysis.

### BACKGROUND

The Internet, also referred to as the worldwide web (WWW), has become a collection of mass media where the content presentation is largely supported by paid advertisements that are added to the web-page content. One of the most common types of advertisements on the Internet is in a form of a banner advertisement. Banner advertisements are generally images or animations that are displayed within a web-page. A typical web-page displayed today is cluttered with many advertisements, which frequently are irrelevant to the content being displayed, and as a result the user's attention is not given to them. Consequently, the advertising price of a potentially valuable display area is lower than it could be because its respective effectiveness is low.

It would therefore be advantageous to provide a solution that would overcome the deficiencies of the prior art by efficiently matching advertised content to contextually related multimedia content displayed in a web-page.

### SUMMARY

Certain embodiments disclosed herein include method and system for matching informative content to a multimedia content element. The method comprises identifying the multimedia content element in a web-page displayed on a user node; generating at least one signature for the multimedia content element; determining a user impression respective of at least one multimedia content element; determining at least one matching concept based on the at least one generated signature and the determined impression; searching for matching informative content based on the matching concept; and determining a display area within the multimedia content element over which the matched informative content can be displayed.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention will be apparent from the following detailed description taken in conjunction with the accompanying drawings.

FIG. 1 is a schematic block diagram of a system for processing multimedia content displayed on a web-page.

FIG. 2 is a flowchart describing the process of matching an advertisement to multimedia content displayed on a web-page.

FIG. 3 is a block diagram depicting the basic flow of information in the signature generator system.

FIG. 4 is a diagram showing the flow of patches generation, response vector generation, and signature generation in a large-scale speech-to-text system.

FIG. 5 is a flowchart describing the process of determining an area within the multimedia content of which an advertisement can be displayed.

FIG. 6 is a screenshot of an image showing the determination of an area to display an advertisement according to an embodiment.

FIG. 7 is a flowchart describing the process of matching content to a multimedia content based on user's characteristics.

### DETAILED DESCRIPTION

It is important to note that the embodiments disclosed herein are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

Certain exemplary embodiments disclosed herein allow matching at least an appropriate advertisement that is relevant to a multimedia content displayed on a web-page, and analyzing the multimedia content displayed on the web-page accordingly. Based on the analysis results, for one or more multimedia content elements included on the web-page, one or more matching signatures are generated. The signatures are utilized to search for appropriate advertisement(s) to be displayed in the web-page. In one embodiment, in addition to the signatures, the advertisements can be searched and used in the web-page, based on extracted taxonomies, context, and/or the user preferences. According to yet another embodiment, the signatures are further utilized to search for an area within the multimedia content displayed on a web-page over which an advertisement can be displayed.

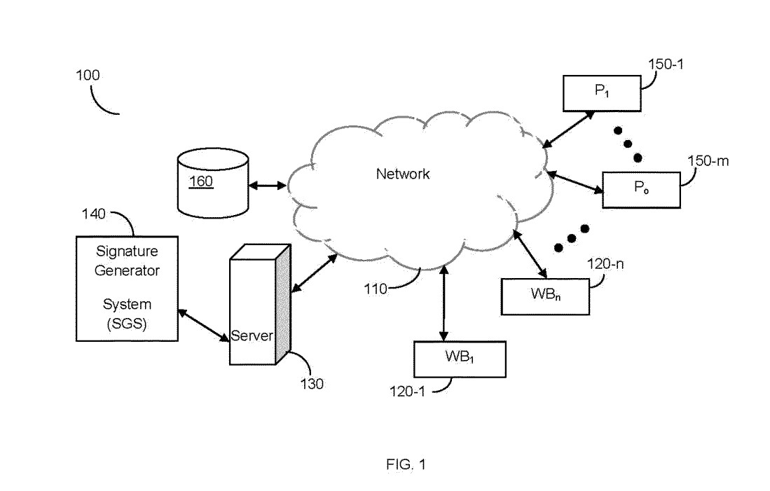

FIG. 1 shows an exemplary and non-limiting schematic diagram of a system 100 for providing advertisements for matching multimedia content displayed in a web-page in accordance with one embodiment. A network 110 is used to communicate between different parts of the system 100. The network 110 may be the Internet, the world-wide-web (WWW), a local area network (LAN), a wide area network (WAN), a metro area network (MAN), and other networks capable of enabling communication between the elements of the system 100.

Further connected to the network 110 are one or more client applications, such as web browsers (WB) 120-1 through 120-n (collectively referred to hereinafter as web browsers 120 or individually as a web browser 120, merely for simplicity purposes). A web browser 120 is executed over a computing device including, for example, personal computers (PCs), personal digital assistants (PDAs), mobile phones, a tablet computer, a wearable computing device, and other kinds of wired and mobile appliances, equipped with browsing, viewing, listening, filtering, and managing capabilities etc., that are enabled as further discussed herein below.

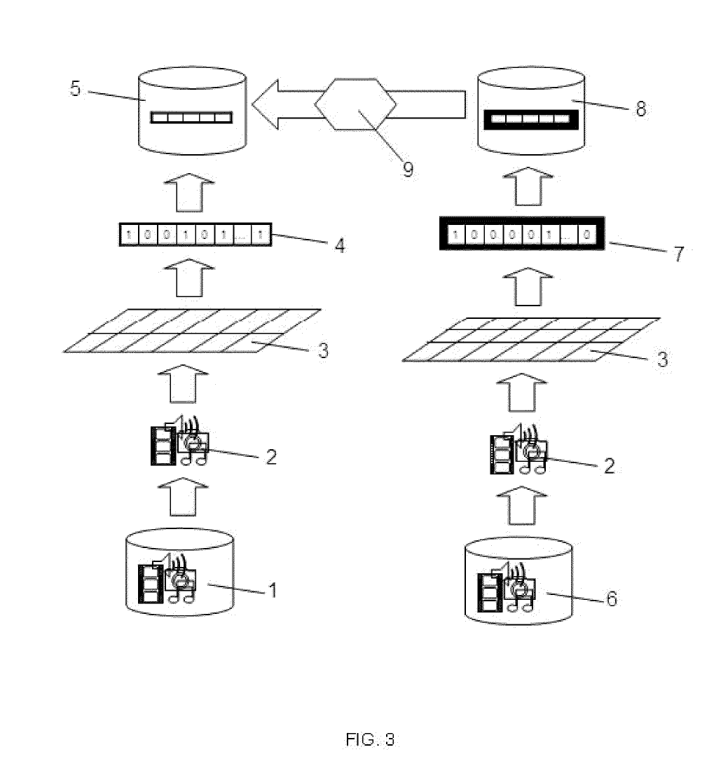

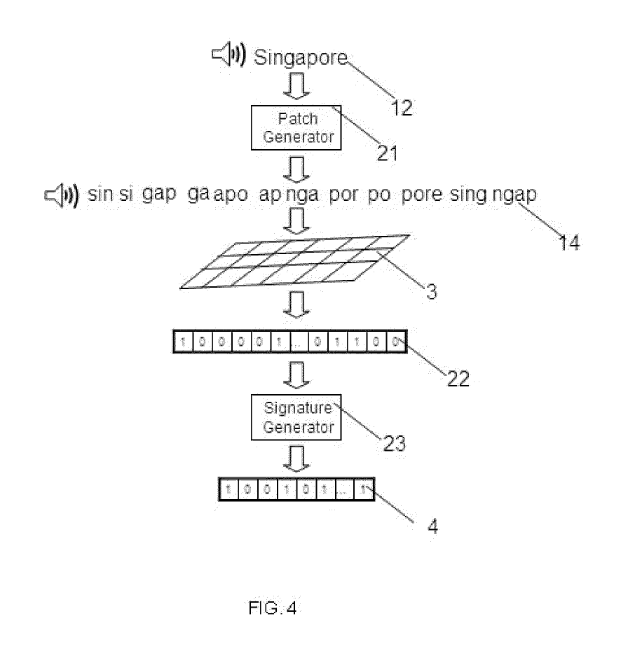

A server 130 is further connected to the network 110 and may provide to a web browser 120 web-pages containing multimedia content, or references therein, such that upon request by a web browser, such multimedia content is provided to the web browser 120. The system 100 also includes a signature generator system (SGS) 140. In one embodiment, the SGS 140 is connected to the server 130. The server 130 is enabled to receive and serve multimedia content and causes the SGS 140 to generate a signature respective of the multimedia content. The process for generating the signatures for multimedia content, is explained in more detail herein below with respect to FIGS. 3 and 4. It should be noted that each of the server 130 and the SGS 140, typically comprises a processing unit, such as a processor (not shown) that is coupled to a memory (also not shown). The memory contains instructions that can be executed by the processing unit. The server 130 also includes an interface (not shown) to the network 110.

A plurality of publisher and/or ad-serving servers 150-1 through 150-m are also connected to the network 110, each of which is configured to generate and send online advertisements to the server 130. The servers 150-1 through 150-m typically receive the advertised content from advertising agencies that set the advertising campaign. In one embodiment, the advertisements may be stored in a data warehouse 160 which is connected to the server 130 (either directly or through the network 110) for further use.

In an exemplary operation of the system 100, a user visits a web-page using a web-browser 120. When the web-page is uploaded on the user's web-browser 120, a request is sent to the server 130 to analyze the multimedia content contained in the web-page. The request to analyze the multimedia content can be generated and sent by a script executed in the web-page, an agent installed in the web-browser, or by one of the publisher servers 150 upon request to upload one or more advertisements to the web-page. The request to analyze the multimedia content may include a URL of the web-page or a copy of the web-page. In one embodiment, the request may include multimedia content elements extracted from the web-page. A multimedia content element may include, for example, an image, a graphic, a video stream, a video clip, an audio stream, an audio clip, a video frame, a photograph, and an image of signals (e.g., spectrograms, phasograms, scalograms, etc.), and/or combinations thereof and portions thereof.

The server 130 is configured to analyze the multimedia content elements in the web-page to detect one or matching advertisements for the multimedia content elements. It should be noted that the server 130 may analyze all or a sub-set of the multimedia content elements contained in the web-page. It should be further noted that the number of matching advertisements that are provided in response for the analysis can be determined based on the number of advertisement banners that can be displayed on the web-page or pre-configured by a campaign manager. The SGS 140 generates for each multimedia content element provided by the server 130 at least one signature. The generated signature(s) may be robust to noise and distribution as discussed below. Then, using the generated signature(s) the server 130 searches the data warehouse 160 for a matching advertisement.

For example, if the signature of an image indicates a “sea shore” then an advertisement for a swimsuit can be a potential matching advertisement. The server 130 further uses the generated signature(s) to determine an area within the multimedia content over which an advertisement can be displayed and then displays the advertisement respective thereto. As another example, if the signature of an image indicates a particular model of car, an advertisement related to that particular model of car or to a car dealership selling such cars may be provided.

The signature generated for an image would enable accurate recognition of the model of the car because the signatures generated for the multimedia content elements, according to the disclosed embodiments, allow for recognition and classification of multimedia content elements, such as, content-tracking, video filtering, multimedia taxonomy generation, video fingerprinting, speech-to-text, audio classification, element recognition, video/image search and any other application requiring content-based signatures generation and matching for large content volumes such as, web and other large-scale databases.

In one embodiment, the signatures generated for more than one multimedia content element are clustered. The clustered signatures are used to search for a matching advertisement. The one or more selected matching advertisements are retrieved from the data warehouse 160 and uploaded to the web-page on the web browser 120 by means of one of the servers 150.

In another embodiment, the server 130 may be further configured to match an advertisement based on a user impression determined respective of the analysis of the multimedia content element. The user impression indicates the user's attention to a certain multimedia content or element.

As a non-limiting example, if a user views and interacts with images of pets and the generated user's impression respective of all these images is positive, the user's profile may be determined as an “animal lover”. A user impression may be determined by the period of time the user viewed or interacted with the multimedia content, and/or a gesture received by the user device such as, a mouse click, a mouse scroll, a tap, and/or any other gesture on a device having touch screen display or a pointing device.

According to another embodiment, a user impression may be determined based on a match between a plurality of multimedia content elements viewed by a user and their respective impression. According to yet another embodiment, a user impression may be generated based on multimedia content that the user uploads or shares on the web, such as social network websites. It should be noted that the user impression may be determined based on one or more of the above identified techniques.

Thereafter, the server 130 is configured to identify based on the at least one signature and the determined user impression at least one matching concept. For example, an image of a tulip would be associated with a concept structure of flowers. The techniques for generating concepts, concept structure, and a concept-based database are disclosed in a co-pending U.S. patent application Ser. No. 13/766,463, filed on Feb. 13, 2013, assigned to common assignee and is hereby incorporated by reference for all the useful information it contains.

The at least one matching concepts is utilized to retrieved informative content, such as advertisements or links to websites. The informative content can be retrieved from a data warehouse 160 and/or information resources (e.g., web servers, big data repositories, etc.) connected to the network 110.

In an embodiment, the server 130 is further configured to determine a display area within the received multimedia content element to display the informative content. Then, the server 130 causes the display of the informative content in the user device at the determined display area.

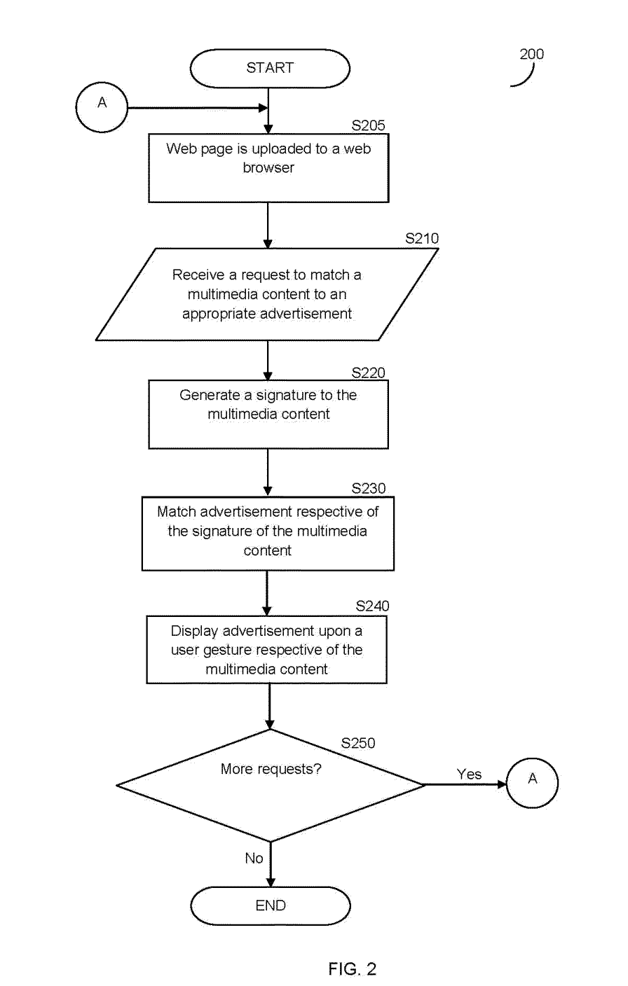

FIG. 2 depicts an exemplary and non-limiting flowchart 200 describing the process of matching an advertisement to a multimedia content element displayed on a web-page. In S205, the method starts when a web-page is provided responsive of a request by one of the web-browsers (e.g., web-browser 120-1). In S210, a request to match at least one multimedia content element contained in the uploaded web-page to an appropriate advertisement item is received. The request can be received from a publisher and/or an ad-serving server (e.g., a server 150-1), a script running on the uploaded web-page, or an agent (e.g., an add-on) installed in the web-browser. S210 can also include extracting the multimedia content elements for a signature that should be generated.

In S220, a signature to the multimedia content element is generated. The signature for the multimedia content element generated by a signature generator is described below. In S230, an advertisement item is matched to the multimedia content element respective of its generated signature. The matching process may include searching for at least one advertisement item respective of the signature of the multimedia content and a display of the at least one advertisement item within the display area of the web-page. The matching of an advertisement to a multimedia content element can be performed by the computational cores that are part of a large scale matching discussed in detail below.

In S240, upon a user's gesture the advertisement item is uploaded to the web-page and displayed therein. An on-image gesture is in a form of a gesture of a user's interaction with a multimedia content element including, but not limited to, web pages. The user's gesture may be: a scroll on the multimedia content element, a press on the multimedia content element, and/or a response to the multimedia content. This ensures that the user's attention is given to the advertised content. In S250 it is checked whether there are additional requests to analyze multimedia content elements, and if so, execution continues with S210; otherwise, execution terminates.

As a non-limiting example, a user uploads a web-page that contains an image of a sea shore. The image is then analyzed and a signature is generated respective thereto. Respective of the image signature, an advertisement item (e.g., a banner) is matched to the image, for example, a swimsuit advertisement. Upon detection of a user's gesture, for example, a mouse scrolling over the sea shore image, the swimsuit ad is displayed.

The web-page may contain a number of multimedia content elements; however, in some instances only a few advertisement items may be displayed in the web-page. Accordingly, in one embodiment, the signatures generated for the multimedia content elements are clustered and the cluster of signatures is matched to one or more advertisement items.

FIGS. 3 and 4 illustrate the generation of signatures for the multimedia content elements by the SGS 140 according to one embodiment. An exemplary high-level description of the process for large scale matching is depicted in FIG. 3. In this example, the matching is for a video content.

Video content segments 2 from a Master database (DB) 6 and a Target DB 1 are processed in parallel by a large number of independent computational Cores 3 that constitute an architecture for generating the Signatures (hereinafter the “Architecture”). Further details on the computational Cores generation are provided below. The independent Cores 3 generate a database of Robust Signatures and Signatures 4 for Target content-segments 5 and a database of Robust Signatures and Signatures 7 for Master content-segments 8. An exemplary and non-limiting process of signature generation for an audio component is shown in detail in FIG. 4. Finally, Target Robust Signatures and/or Signatures are effectively matched, by a matching algorithm 9, to Master Robust Signatures and/or Signatures database to find all matches between the two databases.

To demonstrate an example of signature generation process, it is assumed, merely for the sake of simplicity and without limitation on the generality of the disclosed embodiments, that the signatures are based on a single frame, leading to certain simplification of the computational cores generation. The Matching System is extensible for signatures generation capturing the dynamics in-between the frames.

The Signatures' generation process will now be described with reference to FIG. 4. The first step in the process of signatures generation from a given speech-segment is to breakdown the speech-segment to K patches 14 of random length P and random position within the speech segment 12. The breakdown is performed by the patch generator component 21. The value of the number of patches K, random length P and random position parameters is determined based on optimization, considering the tradeoff between accuracy rate and the number of fast matches required in the flow process of the server 130 and SGS 140. Thereafter, all the K patches are injected in parallel into all computational Cores 3 to generate K response vectors 22, which are fed into a signature generator system 23 to produce a database of Robust Signatures and Signatures 4.

In order to generate Robust Signatures, i.e., Signatures that are robust to additive noise L (where L is an integer equal to or greater than 1) by the Computational Cores 3 a frame ‘i’ is injected into all the Cores 3. Then, Cores 3 generate two binary response vectors: \vec{S} which is a Signature vector, and \vec{RS} which is a Robust Signature vector.

For generation of signatures robust to additive noise, such as White-Gaussian-Noise, scratch, etc., but not robust to distortions, such as crop, shift and rotation, etc., a core Cᵢ={nᵢ} (1≦i≦L) may consist of a single leaky integrate-to-threshold unit (LTU) node or more nodes. The node nᵢ equations are:

$${V}_{i} = {\sum }_{j} {w}_{ij} {k}_{j}$$

$${n}_{i} = \prod ( Vi - {Th}_{x} )$$

where, [symbol] is a Heaviside step function; wᵢⱼ is a coupling node unit (CNU) between node i and image component j (for example, grayscale value of a certain pixel j); kⱼ is an image component ‘j’ (for example, grayscale value of a certain pixel j); Thx is a constant Threshold value, where x is ‘S’ for Signature and ‘RS’ for Robust Signature; and Vi is a Coupling Node Value.

The Threshold values Thₓ are set differently for Signature generation and for Robust Signature generation. For example, for a certain distribution of Vi values (for the set of nodes), the thresholds for Signature (Th_{S}) and Robust Signature (Th_{RS}) are set apart, after optimization, according to at least one or more of the following criteria:
1: For: Vᵢ>Th_{RS}

1−p(V>Th_{S})−1−(1−ε)^{l}<<1

i.e., given that l nodes (cores) constitute a Robust Signature of a certain image I, the probability that not all of these I nodes will belong to the Signature of same, but noisy image, [symbol] is sufficiently low (according to a system's specified accuracy).
2: p(Vᵢ>Th_{RS})≈l/L
   i.e., approximately l out of the total L nodes can be found to generate a Robust Signature according to the above definition.

3: Both Robust Signature and Signature are generated for a certain frame i.

It should be understood that the generation of a signature is unidirectional, and typically yields lossless compression, where the characteristics of the compressed data are maintained but the uncompressed data cannot be reconstructed. Therefore, a signature can be used for the purpose of comparison to another signature without the need of comparison to the original data.

The detailed description of the Signature generation can be found U.S. Pat. Nos. 8,326,775 and 8,312,031, assigned to common assignee, and are hereby incorporated by reference for all the useful information they contain.

A Computational Core generation is a process of definition, selection, and tuning of the parameters of the cores for a certain realization in a specific system and application. The process is based on several design considerations, such as:

(a) The Cores should be designed so as to obtain maximal independence, i.e., the projection from a signal space should generate a maximal pair-wise distance between any two cores' projections into a high-dimensional space.

(b) The Cores should be optimally designed for the type of signals, i.e., the Cores should be maximally sensitive to the spatio-temporal structure of the injected signal, for example, and in particular, sensitive to local correlations in time and space. Thus, in some cases a core represents a dynamic system, such as in state space, phase space, edge of chaos, etc., which is uniquely used herein to exploit their maximal computational power.

(c) The Cores should be optimally designed with regard to invariance to a set of signal distortions, of interest in relevant applications.

Detailed description of the Computational Core generation and the process for configuring such cores is discussed in more detail in U.S. Pat. No. 8,655,801, owned by common assignee, which is hereby incorporated by reference for all that it contains.

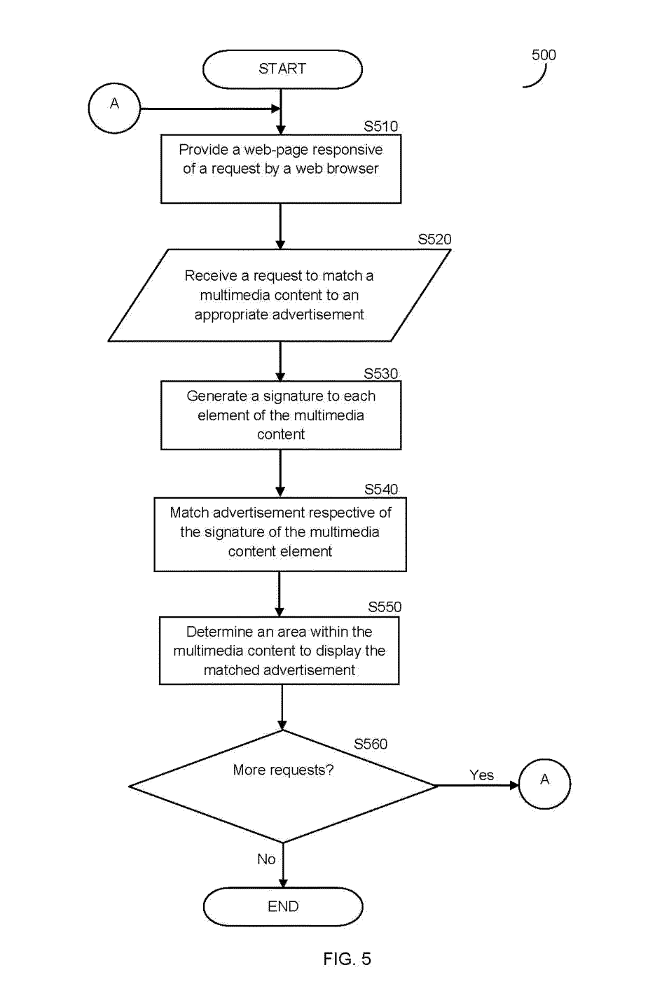

FIG. 5 is an exemplary and non-limiting flowchart 500 describing the process of determination of an area within multimedia content displayed on a web-page of which an advertisement can be displayed. In S510, the method starts when a web-page is provided responsive of a request by one of the web-browsers (e.g., web-browser 120-1).

In S520, a request to match at least one multimedia content element contained in the uploaded web-page to an appropriate advertisement item is received. The request can be received from a publisher server (e.g., a server 150-1), a script running on the uploaded web-page, or an agent (e.g., an add-on) installed in the web-browser. S520 can also include extracting the multimedia content elements for a signature that should be generated.

In S530, a signature to each element within the multimedia content is generated. The signature for each element of the multimedia content is generated by a signature generator as described hereinabove. In S540, an advertisement item is matched to the each element of the multimedia content respective of its generated signature. In one embodiment, the matching of an advertisement to a multimedia content element can be performed by the computational cores that are part of a large scale matching discussed in detail below.

In S550, one or more areas within the multimedia content to display one or more of the matched advertisements respective of the signature(s) is determined. An area to display an advertisement within the multimedia content may be determined based for example, on its texture, its visibility, its contrast, its relativity to the advertisement content, its distance from a certain multimedia content element, etc. Optionally, the matched advertisement is displayed over the determined area. The display of a matched advertisement over the determined area may be displayed upon a user's gesture.

The user's gesture may be: a scroll on the multimedia content, a scroll on the multimedia content element, a press on the multimedia content, a press on the multimedia content element, and/or a response to the multimedia content or to the multimedia content element. According to yet another embodiment an advertising element may be integrated by the server 130 into the multimedia content. For example, in order to advertise a soft drink within an image of a man seating on the beach, a bottle of the soft drink may be displayed in the man's hand by overlaying an image of a soft drink held in a person's hand over the portion of the image where the man's hand is located.

In S560 it is checked whether there are additional requests, and if so, execution continues with S510; otherwise, execution terminates.

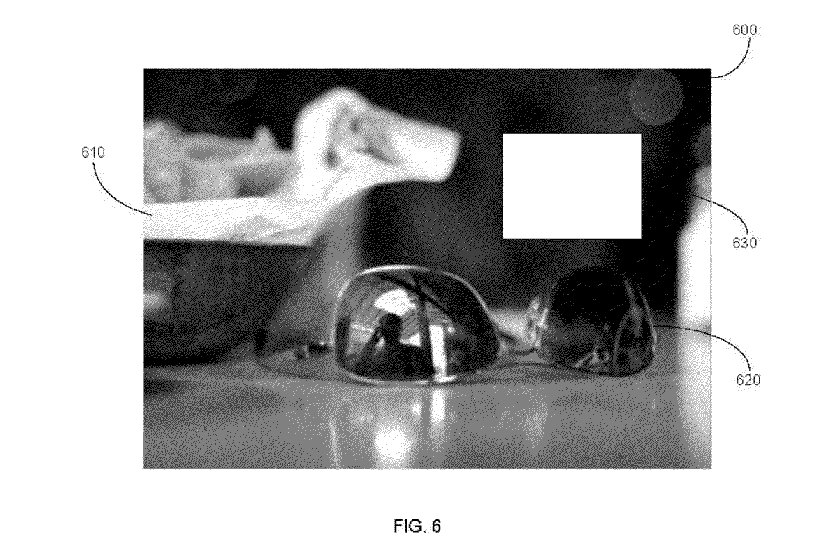

FIG. 6 depicts an exemplary and non-limiting screenshot of an image 600 showing the determination of an area to display an advertisement. A request to match an advertisement to the image 600 displayed over a web-page is received by the server 130. The image is analyzed by the server 130, and a signature to each multimedia content element within the image is generated by the SGS 140. With that respect, a signature is generated to a food bowl 610 and sunglasses 620, both shown in the image 600. Because the area 630, above the sunglasses 620, does not show an element and its texture is flat, it is determined by the server 130 to be an area over which an advertisement for the sunglasses 620 can be displayed.

This determination may be based on generating a signature regarding the texture of the area 630 for the advertisement to be displayed over. Upon recognition of, e.g., a signature related to a flat concept, the server 130 will determine that the area is suitable for display of the advertisement. The process of generating and matching signatures is discussed further hereinabove with respect to FIGS. 3 and 4.

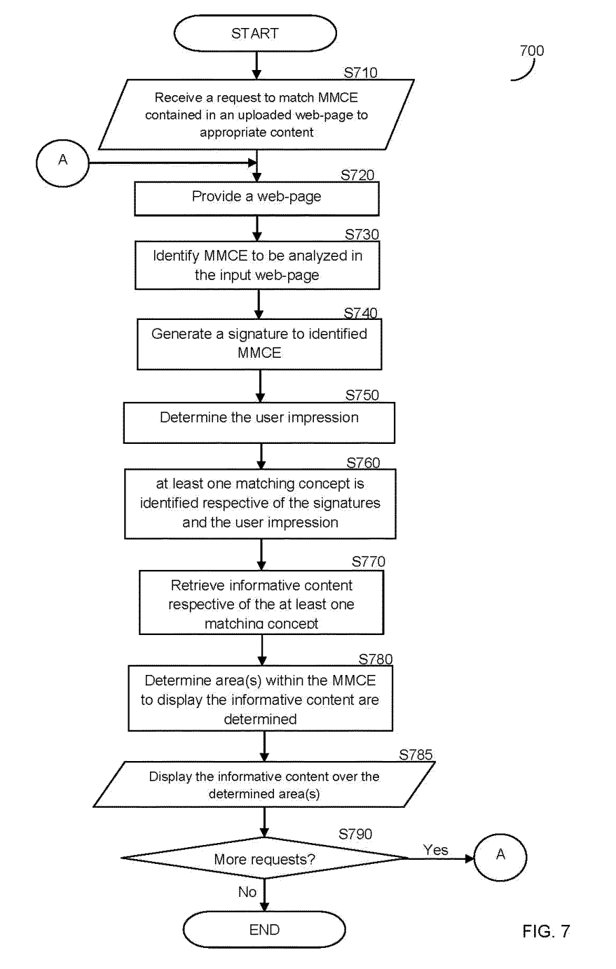

FIG. 7 is an exemplary and non-limiting flowchart 700 describing the process of matching informative content to a multimedia content element based on user impression according to an embodiment. In S710, a request to match at least one multimedia content element contained in an uploaded web-page to appropriate content respective of information related to a user is received. The request can be received from a publisher server (e.g., a server 150-1), a script running on the uploaded web-page, or an agent (e.g., an add-on) installed in the web-browser. The request may be accommodated with additional information pertaining to a user browsing the web-page. Such information may the user location, demographic information related to the user, the user experience, similar users' experience, and so on.

In S720, a web-page is provided responsive of a request by one of the web-browsers (e.g., web-browser 120-1).

In S730, at least one multimedia content element to be analyzed is identified in the input web-page. In S740, at least one signature for the identified multimedia content element is generated. The at least one signature for the identified multimedia content element is generated by a signature generator as described hereinabove.

In S750, the user's impression is determined. The user's impression is the interaction of the user with the multimedia content contained in the uploaded web-page. As an example, if a user's location while interacting with a multimedia content element is determined to be the United States, and the multimedia content is identified as an image of the city of Paris, the impression may be travels to Paris. One exemplary for determining the user impression is disclosed in a co-pending U.S. patent application Ser. No. 13/856,201 to Raichelgauz, et al., which is assigned to common assignee, and is hereby incorporated by reference for all that it contains.

In S760, at least one matching concept is identified respective of the generated signatures and the determined user impression. A concept is a collection of signatures representing elements of the unstructured data and metadata describing the concept. As a non-limiting example, a ‘Superman concept’ is a signature reduced cluster of signatures describing elements (such as multimedia content elements) related to, e.g., a Superman cartoon: a set of metadata providing textual representation of the Superman concept. Techniques for generating concepts and concept structures are also described in U.S. Pat. No. 8,266,185 to Raichelgauz, et al., which is assigned to common assignee, and is hereby incorporated by reference for all that it contains. An exemplary database of concepts is disclosed in a co-pending U.S. patent application Ser. No. 13/766,463 referenced above.

In S770, informative content is retrieved respective of the at least one matching concept. The informative content may include, for example, an advertisement item, an informative link to, for example, Wikipedia®, product placement, etc.

According to one embodiment, the matching of the content to a multimedia content element can be performed by the computational cores that are part of a large scale matching discussed in detail below. The content may be received from one or more publisher servers 150. According to one embodiment, content received from one or more publishers is displayed based on a bid given by the one or more publisher ad-servings, and/or ad-exchange servers.

As a non-limiting example, three ad-exchange servers may be provided a notification of an opportunity to advertise the three respective publishers' content based on signature matching that resulted from identification of a user's impression related to travels to Paris. In this example, the three publishers may be, e.g., airline companies that would offer flights from the United States to Paris. Each publisher may be given the chance to bid on the advertising opportunity. The publisher that provides the highest bid would be awarded the advertising opportunity, and the publisher's server may provide an appropriate advertisement to be displayed on the multimedia content as discussed with respect to S760.

In S780, one or more areas within the multimedia content element in which to display the informative content are determined. An area to display the matched informative content within the multimedia content element may be determined based for example, on its texture, its visibility, its contrast, its relativity to the matched content, its distance from a certain multimedia content element, and the like. Determination of an area to display the matched content is discussed further hereinabove with respect to FIG. 6.

Optionally, in S785, the matched informative content is displayed over the determined area. According to another embodiment, the display of a matched content over the determined area may be displayed upon a user's gesture. The user's gesture may be: a scroll on the multimedia content, a scroll on the multimedia content element, a press on the multimedia content, a press on the multimedia content element, and/or a response to the multimedia content or to the multimedia content element.

According to yet another embodiment, the matched informative content can be integrated into the input multimedia content element. For example, in order to advertise a soft drink in an image of a man sitting on the beach, a bottle of the soft drink may be displayed in the man's hand. In S790 it is checked whether there are additional requests, and if so, execution continues with S720; otherwise, execution terminates.

As a non-limiting example, a user uploads a web-page that contains an image of a sea shore. The context of the web-page is identified as travel related. The user is identified as located in New York City and the time of the impression is identified as mid-December. Respective of the image signature and the user's impression, an advertisement item (e.g., a banner) is matched to the image, for example, an advertisement of a flight to Hawaii is displayed near the image of the sea shore.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for matching informative content to a multimedia content element, comprising:
identifying the multimedia content element in a web-page displayed on a user node;
generating at least one signature for the multimedia content element;
determining a user impression respective of at least one multimedia content element;
determining at least one matching concept based on the at least one generated signature and the determined impression;
searching for matching informative content based on the matching concept; and
determining a display area within the multimedia content element over which the matched informative content can be displayed.

2. The method of claim 1, further comprising:
causing the display of the matched informative content within the determined display area.

3. The method of claim 1, wherein the matched informative content is any one of:
one or more advertisement items, one or more informative links, and one or more product placements.

4. The method of claim 2, wherein the matched informative content is displayed upon a gesture of a user that is detected by the user node.

5. The method of claim 4, wherein the user gesture is any one of: a scroll on the media content, a press on the media content, and a response to the media content.

6. The method of claim 1, wherein generating the user impression respective of the at least one multimedia content element further comprises:
receiving a tracking information gathered with respect to an interaction of a user with the multimedia content element;
filtering the tracking information to remove meaningless measures;
assigning a number for each meaningful measure and indication in the tracking information; and
computing a quantitative measure for the user impression as a summation of the assigned number.

7. The method of claim 1, wherein the at least one concept is determined by querying a concept-based database using the at least one generated signature.

8. The method of claim 1, wherein the multimedia content is at least one of: an image, graphics, a video stream, a video clip, an audio stream, an audio clip, a video frame, a photograph, images of signals, combinations thereof, and portions thereof.

9. A non-transitory computer readable medium having stored thereon instructions for causing one or more processing units to execute the method according to claim 1.

10. A system for matching informative content to a multimedia content element, comprising:
an interface to a network for receiving at least a web-page containing at least the multimedia content element; and
a processor; and
a memory coupled to the processor, the memory contains instructions that when executed by the processor cause the system to:
identify the multimedia content element in a web-page displayed on a user node;
generate, by a signature generator, at least one signature for the multimedia content element;
determine a user impression respective of at least one multimedia content element;
determine at least one matching concept based on the at least one generated signature and the determined impression;
search for matching informative content based on the matching concept; and
determine a display area within the multimedia content element over which the matched informative content can be displayed.

11. The system of claim 10, wherein the system is further configured to:
cause the display of the matched content within the determined display area.

12. The system of claim 10, wherein the matched informative content is any one of:
one or more advertisement items, one or more informative links, and one or more product placements.

13. The system of claim 10, wherein the signature generator is communicatively connected to the processor.

14. The system of claim 13, wherein the signature generator system further comprises:
a plurality of computational cores enabled to receive the multimedia content elements, wherein each computational core of the plurality of computational cores has properties that are at least partly statistically independent of the other computational cores and wherein the properties are set independently of each other core.

15. The system of claim 13, further comprises:
a database for maintaining the matched informative content and the at least one generated signature.

16. The system of claim 11, wherein the server is further configured to display the matched informative content within the determined display area upon detection of a user's gesture.

17. The system of claim 16, wherein the user gesture is one of: a scroll on the multimedia content, a press on the multimedia content, a press on the multimedia content element, a response to the multimedia content, and a response to the multimedia content element.

18. The system of claim 13, wherein the server is further configured to:
receive a tracking information gathered with respect to an interaction of a user with the multimedia content element;
filter the tracking information to remove meaningless measures;
assign a number for each meaningful measure and indication in the tracking information; and
compute a quantitative measure for the user impression as a summation of the assigned number.

19. The system of claim 18, wherein the at least one concept is determined by querying a concept-based database using the at least one generated signature.

20. The system of claim 11, wherein the multimedia content element is at least one of: an image, graphics, a video stream, a video clip, an audio stream, an audio clip, a video frame, a photograph, images of signals, combinations thereof, and portions thereof.
